(19) United States
(12) Patent Application Publication
(10) Pub. No.: US 2022/0027428 A1
(43) Pub. Date: Jan. 27, 2022

(54) SECURITY SYSTEM FOR ADAPTIVE TARGETED MULTI-ATTRIBUTE BASED IDENTIFICATION OF ONLINE MALICIOUS ELECTRONIC CONTENT

(71) Applicant: BANK OF AMERICA CORPORATION, Charlotte, NC (US)

(72) Inventor: Martin Andrew Sutton, Chester (GB)

(73) Assignee: BANK OF AMERICA CORPORATION, Charlotte, NC (US)

(21) Appl. No.: 16/936,808

(22) Filed: Jul. 23, 2020

(51) Int. Cl. G06F 16/955; G06F 21/57; G06F 9/54; G06F 21/56

(52) U.S. Cl. CPC G06F 16/9566; G06F 21/577; G06F 2221/2119; G06F 21/563; G06F 9/547

(57) ABSTRACT

Embodiments of the invention are directed to a system, method, or computer program product for adaptive targeted multi-attribute based identification of online malicious electronic content. In this regard, the is structured for enhancing network security by extracting and dynamically analyzing web components of the malicious web resources, and mitigating unsecured activity via the identified malicious web resources. Specifically, the invention extracts web resource data from one or more programmed application programming interfaces. The invention further extract a source code web component associated with a first uniform resource locator. The invention further configures an adaptive analysis action for analyzing the first uniform resource locator based on at least web component attributes and a structure of the source code web component associated with the first URL.

### FIELD OF THE INVENTION

In general, the present invention is directed to a security system for adaptive targeted multi-attribute based identification of online malicious electronic content. Furthermore, the present invention embraces a novel, proactive approach to enhancing network security by detecting malicious web resources, extracting and dynamically analyzing web components of the malicious web resources, and preventing unsecured activity via the identified malicious web resources.

### BACKGROUND

Over the last few years, there has been a significant increase in the number of electronic activities, particularly online activities from computers and mobile devices, due to widespread use of smartphone, tablet computers, laptop computers and electronic computing devices in general. These electronic activities are typically entail accessing, communicating with, sending data to and viewing/receiving outputs of a multitude of web resources, such as websites. However, the multitude of web resources may be unsecure or malicious, and whose veracity cannot be easily confirmed by users before the unsecure or malicious web resources initiate unauthorized actions that may jeopardize the security and safety of users' electronic information and that of user devices. Moreover, the unsecure or malicious web resources/websites may be surreptitiously structured/simulated to resemble/mimic and adopt the look-and-feel of authentic/genuine web resources/websites, such that a user accessing such malicious resources/websites cannot easily differentiate between the unsecure or malicious simulation and the actual authentic web resource that they are modeled after, thereby precluding the user from recognizing that they are unsecure or malicious. Therefore, identifying unsecure or malicious web resources is crucial for preventing unauthorized exposure of users' electronic information and ensuring the security of user devices.

The present invention provides a novel security system for adaptive targeted multi-attribute based identification of online malicious electronic content, which provides a solution to the problem of proactively identifying, customizing the analysis of and mitigating the adverse effects of unsecure or malicious web resources before they cause detrimental unauthorized actions. The previous discussion of the background to the invention is provided for illustrative purposes only and is not an acknowledgement or admission that any of the material referred to is or was part of the common general knowledge as at the priority date of the application.

### SUMMARY

In one aspect, the present invention is directed to in general a system, method and computer program product for adaptive targeted multi-attribute based identification of online malicious electronic content. The system is configured to provide a novel, proactive approach to enhancing network security by detecting malicious web resources, extracting and dynamically analyzing web components of the malicious web resources, and preventing unsecured activity via the identified malicious web resources. The system typically includes at least one processing device operatively coupled to at least one memory device and at least one communication device configured to establish operative communication with a plurality of networked devices via a communication network. The system also typically includes a module stored in the at least one memory device comprising executable instructions that when executed cause the processing device and hence the system to perform one or more functions described below. In some embodiments, the system is configured to: extract web resource data from one or more programmed application programming interfaces (APIs), wherein the web resource data comprises one or more uniform resource locators (URLs); extract a source code web component associated with a first URL of the one or more URLs from a first storage location, wherein the source code web component is associated with source code used to generate a first website associated with the first URL; determine one or more web component attributes of the source code web component associated with the first URL based on analyzing the source code web component, wherein the one or more web component attributes comprise a source code web component identifier associated with the source code web component; analyze the source code web component based on (i) the web component attributes and (ii) a structure of the source code web component associated with the first URL; configure an adaptive analysis action for analyzing the first URL of the one or more URLs based on at least (i) the web component attributes and (ii) a structure of the source code web component associated with the first URL; implement the adaptive analysis action for determining whether the first URL is malicious; in response to determining that the first URL is malicious URL, construct security data associated with the first URL; and transmit the security data to an entity system associated with an entity, such that the security data is processed to prevent unsecured actions associated with the first URL determined to be malicious.

In some embodiments, or in combination with any of the previous embodiments, the source code web component is a phishing kit associated with the first URL, and the source code web component identifier is a phishing kit ID.

In some embodiments, or in combination with any of the previous embodiments, the invention is structured to: load, a first web resource associated with the first URL, wherein the first web resource is a first website associated with the first URL; capture a current web resource image from the loaded first website associated with the first URL; capture an entity web resource image from a loaded authentic website associated with the entity; and compare image components of the current web resource image with image components of the entity web resource image to determine a similarity indicator metric.

In some embodiments, or in combination with any of the previous embodiments, capturing the entity web resource image further comprises: determining that a portion of the web resource image is associated with an product item; determining that the product item is associated with the entity; determining an authentic website associated with the product item of the entity; and loading the authentic website associated with the product item of the entity.

In some embodiments, or in combination with any of the previous embodiments, the first storage location is a server location, the first URL is associated with a first web resource comprising a first website. Here, extracting the source code web component associated with the first URL further comprises: determining the first storage location associated with the first web resource of the first URL; searching the first storage location for files associated with the first web resource of the first URL; and retrieving the source code web component from the files associated with the first web resource of the first URL.

In some embodiments, or in combination with any of the previous embodiments, the one or more web component attributes further comprise a web domain, a web resource, and/or an electronic communication associated with the source code web component.

In some embodiments, or in combination with any of the previous embodiments, analyzing the source code web component based on the web component attributes and the structure of the source code web component associated with the first URL, further comprises: determining prior files associated with the source code web component identifier associated with a previous version of the web resource of the first URL; searching the first storage location for current files associated with a current version of the web resource of the first URL; and in response to identifying new files in the current files associated with the current version of web resource of the first URL that are absent from the prior files associated with the previous version of the web resource of the first URL, determine an update of the web resource of the first URL; and wherein the adaptive analysis action is configured based on the determined update of the web resource of the first URL, wherein the new adaptive analysis is structured for extracting and processing the identified new files to determine whether the first URL is malicious.

In some embodiments, or in combination with any of the previous embodiments, analyzing the source code web component based on the web component attributes and the structure of the source code web component associated with the first URL, further comprises: determining one or more actions initiated by the web resource associated with the first URL upon execution; and determining that a first action of the one or more actions is an unsecure action; and wherein the adaptive analysis action is configured based on the determined unsecure action, wherein the new adaptive analysis is structured for analyzing the unsecure action to determine whether the first URL is malicious.

In some embodiments, or in combination with any of the previous embodiments, the new adaptive analysis is structured for: searching the first storage location for files associated with the determined unsecure action; based on the files associated with the unsecure action, determining one or more users affected by the unsecure action.

In some embodiments, or in combination with any of the previous embodiments, analyzing the source code web component based on the web component attributes and the structure of the source code web component associated with the first URL comprises determining that the web resource of first URL comprises a preprogrammed alteration of a product item of the entity. Here, the new adaptive analysis is structured for: analyzing a domain, a sub-domain, and/or a path structure of the first URL; and determining whether the source code web component is (i) associated with a third-party domain targeting the entity, and/or is (ii) associated with a compromised domain of the entity.

In some embodiments, or in combination with any of the previous embodiments, the security data associated with the first URL comprises the source code web component and/or the web component attributes. Here, constructing the security data associated with the first URL further comprises: constructing a benign deactivated URL by modifying the first URL such that the deactivated URL is not associated with unsecure actions of the first website; and constructing an image analysis of the web resource of the first URL determined to be malicious.

In some embodiments, or in combination with any of the previous embodiments, determining the one or more web component attributes of the source code web component associated with the first URL further comprises: searching the first storage location for additional files associated with the one or more web component attributes; and retrieving the additional files associated with the one or more web component attributes from the first storage location.

In some embodiments, or in combination with any of the previous embodiments, the invention is structured to modify the web resource data by: determining, for each of the one or more URLs of the web resource data, (i) whether an associated web resource is active, and (ii) whether the associated web resource is associated with a predetermined entity; determining that a second URL of the one or more URLs is a false positive based on determining (i) that the associated web resource is inactive or removed, and (ii) that the associated web resource is associated with a predetermined entity; and removing the second URL from the web resource data.

In some embodiments, or in combination with any of the previous embodiments, the invention is structured to process the extracted web resource data by: indexing, for each of the one or more URLs of the web resource data, via a component separator character of the URL, by (i) expanding the URL after the component separator character and/or (ii) truncating the URL at the component separator character; determining, for each of the one or more URLs of the web resource data, availability of new web resources based on determining that the new web resources are associated with the expanded URL and/or the truncated URL; and appending the web resource data to include the expanded URL and/or the truncated URL.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 depicts a system environment 100 for adaptive targeted multi-attribute based identification of online malicious electronic content, in accordance with an aspect of the present invention;

FIG. 2 schematically depicts a high level process flow 200 for adaptive targeted multi-attribute based identification of online malicious electronic content, in accordance with some embodiments of the invention;

FIG. 3A schematically depicts a high level process flow 300A for dynamic identification and adaptive targeted multi-attribute analysis of web resources, in accordance with some embodiments of the invention;

FIG. 3B schematically depicts a high level process flow 300B for dynamic identification and adaptive targeted multi-attribute analysis of web resources, in accordance with some embodiments of the invention;

FIG. 4 schematically depicts a high level process flow 400 for mitigation of the unsecure activities and outputs of the identified malicious URLs, in accordance with some embodiments of the invention; and

FIG. 5 depicts a schematic illustration of constructed security data 500, in accordance with some embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, or the like. The account is associated with and/or maintained by an entity. In other embodiments, an “entity” may not be a financial institution.

Unless specifically limited by the context, a “user activity”, “transaction” or “activity” refers to any communication between the user and a financial institution or another entity. In some embodiments, for example, a user activity may refer to a purchase of goods or services, a return of goods or services, a payment transaction, a credit transaction, or other interaction involving a user's bank account. As another example, in some embodiments, a user activity may refer to viewing account balances, modifying user information and contact information associated with an account, modifying alert/notification preferences, viewing transaction/activity history, transferring/redeeming loyalty points and the like. In some embodiments, the user activity is associated with an entity application stored on a user device, for example, a digital wallet application, a mobile/online banking application, a merchant application, a browser application, a social media application and the like. Typically, a user activity is an electronic transaction or electronic activity in which the user is employing a mobile device, computing device, or other electronic device to initiate, execute and/or complete the activity.

As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a user activity or transaction may refer to one or more of a sale of goods and/or services, an account balance inquiry, a rewards transfer, an account money transfer, opening a bank application on a user's computer or mobile device, a user accessing their e-wallet (e.g., mobile wallet) or online banking account or any other interaction involving the user and/or the user's device that is detectable by the financial institution. As further examples, a user activity may occur when an entity associated with the user is alerted via the transaction of the user's location. A user activity may occur when a user accesses a building or a dwelling, uses a rewards card, and/or performs an account balance query. A user activity may occur as a user's device establishes a wireless connection, such as a Wi-Fi connection, with a point-of-sale terminal. In some embodiments, a user activity may include one or more of the following: purchasing, renting, selling, and/or leasing goods and/or services (e.g., groceries, stamps, tickets, DVDs, vending machine items, and the like); withdrawing cash; making payments (e.g., paying monthly bills; paying federal, state, and/or local taxes; and the like); sending remittances; transferring balances from one account to another account; loading money onto stored value cards (SVCs) and/or prepaid cards; donating to charities; and/or the like.

As used herein, an “online banking account” is an account that is associated with one or more user accounts at a financial institution. For example, the user may have an online banking account that is associated with the user's checking account, savings account, investment account, and/or credit account at a particular financial institution. Authentication credentials comprising a username and password are typically associated with the online banking account and can be used by the user to gain access to the online banking account. The online banking account may be accessed by the user over a network (e.g., the Internet) via a computer device, such as a personal computer, laptop, or mobile device (e.g., a smartphone or tablet). The online banking account may be accessed by the user via a mobile or online banking website or via a mobile or online banking application. A customer may access an online banking account to view account balances, view transaction history, view statements, transfer funds, and pay bills. More than one user may have access to the same online banking account. In this regard, each user may have a different username and password. Accordingly, one or more users may have a sub-account associated with the online banking account.

A “user” may be an individual or group of individuals associated with an entity who receives one or more electronic communications. In some embodiments, the “user” may be a financial institution user (e.g., an account holder or a person who has an account (e.g., banking account, credit account, or the like)). In one aspect, a user may be any financial institution user seeking to perform user activities associated with the financial institution or any other affiliate entities associated with the financial institution. In some embodiments, the user may be an individual who may be interested in opening an account with the financial institution. In some other embodiments, a user may be any individual who may be interested in the authentication features offered by the financial institution/entity. In some embodiments, a “user” may be a financial institution employee (e.g., an underwriter, a project manager, an IT specialist, a manager, an administrator, an internal operations analyst, bank teller or the like) capable of operating the system described herein. For purposes of this invention, the term “user” and “customer” may be used interchangeably.

An “electronic communication” may refer to network communication signals, data transfers, data bits/bytes being transmitted, an email, a text message, a social media post, a message associated with a messaging application, a user device notification, a notification associated with an application of a user device, a pop-up notification, a communication associated with exchanging messages between users/devices using electronic devices, and/or the like.

A “web resource” as used herein may refer to online resources that are connected to and accessed via a network, such as websites (also referred to as webpages). Specifically, web resources are technology resources associated with, connected to, served by, or available through a system/device/computer/server and a communications/telecommunications network (such as the Internet). Typically, each of the web resources are associated with a Uniform Resource Identifier (URI). The Uniform Resource Identifier (URI) may be a string of characters that unambiguously identifies a particular web resource and indicates the means for accessing/viewing/visiting the resource. Typically, the URIs follow a predefined set of syntax rules, and also provide for extensibility through a separately defined hierarchical naming scheme (e.g. http://). In some embodiments, web resources refer to websites or webpages which may be used interchangeably herein.

A “Uniform Resource Locator” (URL), may be a reference to a web resource that specifies its location on a computer network. Here, in some instances, the URL is a specific type of Uniform Resource Identifier (URI). URLs are typically associated with web resource such as reference web pages (e.g., via “http”), but are also used for file transfer (e.g., via “ftp”), email (e.g., via “mailto”), database access (e.g., via “JDBC”), and/or the like. Typically, web browsers display the URL of a website/webpage above the page in an address bar. A typical URL could have the form http://www.sample.com/index.html, which indicates a protocol (http), a hostname (www.sample.com), and a file name (index.html).

“Web resource data” may refer to identifying information associated with the web resources, and may comprise URIs associated with the web resources. In some embodiments, web resources refer to websites/webpages, and web resource data refers to a list of URLs associated with the websites/webpages. That said, in other embodiments, it is contemplated that web resources may refer to websites/webpages as well as URLs, and web resource data may refer to a list of associated URLs.

With advancements in technology infrastructures and wireless communication implementation, user devices, such as laptop computers, tablet computers, mobile phones, smart phones, wearable devices, smart television, and the like are common. Each user is typically associated with multiple user devices, e.g., a user may be associated with a smart phone, a laptop computer and another smart device (such as a wearable device, a smart television, a tablet device and/or the like). These user devices have the capability to hold large amounts of information, including personal information, resource data (information associated with user resources like banking accounts, payment instruments like credit cards and the like), and/or have access to a central storage of such data. In other aspects the user devices may enable access to resource data stored at other sources and databases based on requisite authorization. These devices may also be configured to enable the user to perform one or more activities, transactions or resource transfers through an application via online banking, mobile banking, mobile wallets and the like. As such, advancements in technology have facilitated there has been a significant increase in the number of electronic activities, particularly online activities from computers and mobile devices, due to widespread use of smartphone, tablet computers, laptop computers and electronic computing devices in general. These electronic activities are typically entail accessing, communicating with, sending data to and viewing/receiving outputs of a multitude of web resources, such as websites.

First, the multitude of web resources may be unsecure or malicious, and whose veracity cannot be easily confirmed by users before the unsecure or malicious electronic communications initiate unauthorized actions (e.g., a breach of security (e.g., a phishing event) where unauthorized access to user information and devices may have been obtained by unauthorized individuals, unbeknownst to the user) adversely affect the security of user information and compromise the security of not just the user information but also user devices and other connected network devices. Typically, the veracity of the unsecure web resources may not be easily confirmed by the user. Moreover, the unsecure or malicious web resources/websites may be surreptitiously structured/simulated to resemble/mimic and adopt the look-and-feel of authentic/genuine web resources/websites, such that a user accessing such malicious resources/websites cannot easily differentiate between the unsecure or malicious simulation and the actual authentic web resource that they are modeled after, thereby precluding the user from recognizing that they are unsecure or malicious. Here, the user may input user information (e.g., login information, email information, user identifying information, etc.) into the interface of the unsecure or malicious simulation, believing it to be the actual authentic web resource instead. Moreover, the malicious web resource (e.g., URL, website, etc.) may initiate unauthorized downloads of files onto the user's device upon the user when the user merely clicks on them, without first asking the user's permission. The user may not be aware of a compromise of the user data or user device until the intercepted data is used to perform at least one unauthorized activity/transaction at a later time after a significant time lapse, while the user may continue to utilize the malicious web resource in the meantime. Therefore, identifying unsecure or malicious web resources is crucial for preventing unauthorized exposure of users' electronic information and ensuring the security of user devices.

Second, the behaviors, traits and actions of malicious web resources are ever changing and evolving. Conventional technology/systems are limited in the malicious content they can identify. Conventional technology/systems may rely heavily on historically identified malicious web resources by individuals, even though current malicious web resources may be distinct from the historically identified malicious web resources such that the behaviors, traits and actions of the historically identified malicious web resources would not be of use in identifying the current malicious web resources. Here, merely comparing the data associated with historically identified malicious web resources, with that of current malicious web resources could lead to erroneously determining that the current malicious web resources are not malicious. Accordingly, there is a further need for overcoming these drawbacks/problems of current technology.

The present invention alleviates the foregoing deficiencies of, and provides solutions to the foregoing problems of conventional technology/systems with its novel security system for adaptive targeted multi-attribute based identification of online malicious electronic content. As such, the present invention is structured for proactively identifying, customizing the analysis of and mitigating the adverse effects of unsecure or malicious web resources before they cause detrimental unauthorized actions. Moreover, the present invention is capable of not only (i) analyzing of the structure (e.g., source code) and working of current malicious web resources (without extensively relying on mere historically identified web resources and comparing the two), but also (ii) analyzing a variety of attributes (e.g., web components) of the web resource, and (iii) customizing, adapting and tailoring the analysis to each malicious web resource being analyzed/studied, thereby providing a custom/bespoke and dynamic analysis of malicious web resources. Moreover, the present invention is configured for enhancing network security by detecting malicious web resources, extracting and dynamically analyzing web components of the malicious web resources, and preventing unsecured activity via the identified malicious web resources.

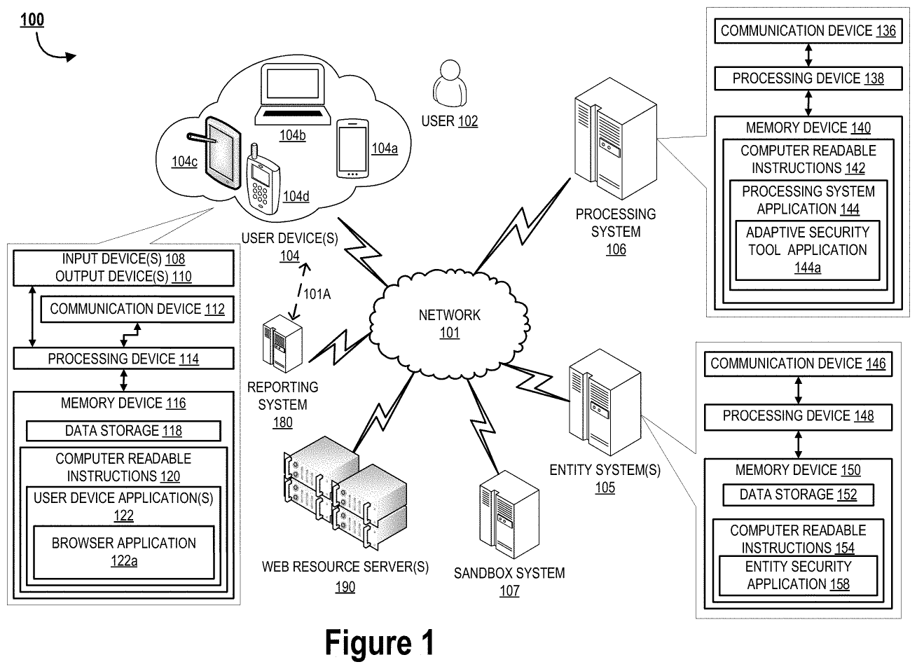

FIG. 1 illustrates a system environment 100 for adaptive targeted multi-attribute based identification of online malicious electronic content, in accordance with one embodiment of the present invention. FIG. 1 provides a unique system that includes specialized servers and systems, communicably linked across a distributive network required to perform the functions of enhancing network security by detecting malicious web resources, extracting and dynamically analyzing web components of the malicious web resources, and preventing unsecured actions/activity of the identified malicious web resources. As illustrated in FIG. 1, a processing system 106 is operatively coupled, via a network 101 to user system(s) 104 (e.g., a plurality of user devices 104a-104d), a reporting system 180, a sandbox testing system 107, entity system(s) 105 (e.g., a system associated with one or more brands or products (referred to as product items), a financial institution system, a merchant system, other systems associated with a user 102 and/or other systems/servers associated with hosting web resources such as web resource server(s) 190) and/or other systems not illustrated herein. In this way, the processing system 106 can send information to and receive information from the user device(s) 104, the entity system 105 and the sandbox testing system 107. FIG. 1 illustrates only one example of an embodiment of the system environment 100, and it will be appreciated that in other embodiments one or more of the systems, devices, or servers may be combined into a single system, device, or server, or be made up of multiple systems, devices, or servers.

The network 101 may be a system specific distributive network receiving and distributing specific network feeds and identifying specific network associated triggers. The network 101 may also be a global area network (GAN), such as the Internet, a wide area network (WAN), a local area network (LAN), or any other type of network or combination of networks. The network 101 may provide for wireline, wireless, or a combination wireline and wireless communication between devices on the network 101. In some embodiments, the network 101 may enable communication between devices thorough near-field communication, transmission of electromagnetic waves, sound waves, light waves or any other suitable means.

In some embodiments, the user 102 is an individual that has, owns or is otherwise associated with one or more user devices 104, and typically a plurality of user devices 104, that are structured for accessing web resources (such as websites, Uniform Resource Locators (URLs), user applications, widgets, etc., which may be hosted on or whose source code may be stored on web resource server(s) 190) that are structured for receiving and displaying electronic data and/or that facilitate/allow the user to view data, input data and/or perform one or more user activities (e.g., view data online, view websites, stream electronic content, interact with other individuals online, perform online purchases, bill payments, etc., perform activities online, etc.). The user devices typically comprise one or more of a smart phone 104a, a laptop or desktop computer 104b, a mobile phone or a personal digital assistant 104d, a tablet device 104c, wearable smart devices, smart television devices, home controllers, smart speakers, and/or other computing devices. In some embodiments, the user may be associated with a first user device (e.g., the tablet device 104c, a laptop or desktop computer 104b, or another smart/computing device) and a second user device (e.g., the smart phone 104a, or any of the user devices listed above). Although referred to as “a user 102”, it is understood that “user 102” may refer to multiple users 102, each of whom may be associated with one or more user devices 104.

FIG. 1 also illustrates a representative user system/device 104. As discussed, the user device(s) 104 may be, for example, a desktop personal computer, a mobile system, such as a cellular phone, smart phone, personal digital assistant (PDA), laptop, or the like, and each of the user devices (e.g., devices 104a-104d) may comprise the technical/electronic components described herein. The user device(s) 104 generally comprises a communication device 112, a processing device 114, a memory device 116, input device(s) 108 and output device(s) 110. The user device 104 may comprise other devices that are not illustrated, configured for location determination/navigation (GPS devices, accelerometers and other positioning/navigation devices), for authentication (fingerprint scanners, microphones, iris scanners, facial recognition devices/software and the like), for image capture (cameras, AR devices, and the like), for display (screens, hologram projectors and the like), and other purposes. The user device 104 is a computing system that enables the user to view/access web resources online, perform activities via web resources online, receive one or more electronic communications and/or perform one or more user activities. The processing device 114 is operatively coupled to the communication device 112, input device(s) 108 (e.g., keypads/keyboards 108a, touch screens 108b, mouse/pointing devices 108c, gesture/speech recognition sensors/devices, microphones, joysticks, authentication credential capture devices listed above, image capture devices, and other peripheral input devices), output device(s) 110 (screens 110a-110b, speakers, printers and other peripheral output devices) and other devices/components of the user device. The processing device 114 uses the communication device 112 to communicate with the network 101 and other devices on the network 101, such as, but not limited to the reporting system 180, the processing system 106, the web resource server(s) 190, etc. As such, the communication device 112 generally comprises a modem, server, or other device for communicating with other devices on the network 101.

Each user device 104a-104d, typically comprises one or more user input devices 108, that are configured to receive instructions, commands, data, authentication credentials, audio/visual input and other forms of user input from the user, and transmit the received user input to the processing device 114 of the user device for processing. Similarly, each user device 104a-104d, typically comprises one or more user output devices 110, that are configured to transmit, display (e.g., via a graphical user interface), present, provide or otherwise convey an user output to the user (e.g., user output from web resources such as websites), based on instructions from the processing device 114 of the user device. In some embodiments, the one or more user input devices 108 and/or one or more user output devices 110 are dual-function devices that are configured to both receive user input from the user and display output to the user (e.g., a touch screen display of a display device). For example, the dual function input devices 108 and/or the output devices 110 may present a user interface associated with one or more user device applications 112 (e.g., a graphical user interface) that is configured to receive user input and also provide user output.

The user device 104 comprises computer-readable instructions 120 and data storage 118 stored in the memory device 116, which in one embodiment includes the computer-readable instructions 120 of one or more user applications 122 (typically user applications 122 such as operating system applications, device applications, third party applications, browser applications 122a, network applications, and/or the like) that are structured for accessing web resources (such as websites, Uniform Resource Locators (URLs), user applications, widgets, etc., which may be hosted on or whose source code may be stored on web resource server(s) 190)) that are structured for receiving and displaying electronic data and/or that facilitate/allow the user to view data, input data and/or perform one or more user activities (e.g., view data online, view websites, stream electronic content, interact with other individuals online, perform online purchases, bill payments, etc., perform activities online, etc.).

As discussed, in some embodiments, the user device 104 may refer to multiple user devices that may be configured to communicate with the processing system 106 and/or the entity system 105 via the network 101. In some embodiments, the processing system 106, and/or the entity system 105 may transmit control signals to the user device 104, configured to cause the user application(s) 122 to perform one or more functions or steps associated with adaptive targeted multi-attribute based identification of online malicious electronic content, such as allowing the user 102 to flag potential malicious web resources (such as URLs) or web resources (such as URLs) that are suspected to be malicious. Typically, once the user 102 flags one or more web resources (e.g., URLs) as being potentially malicious, the web resource data associated with the flagged web resources (e.g., URLs) is transmitted to the reporting system 180, e.g., via a communication link 101A. The processing system 106 may extract the web resource data associated with the flagged web resources (e.g., URLs) from the reporting system 180.

As further illustrated in FIG. 1, the processing system 106 generally comprises a communication device 136, a processing device 138, and a memory device 140. The processing system 106 is also referred to as a security system 106 herein. As used herein, the term “processing device” or “processor” (e.g., processing devices 114, 138 and 148) generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 138 is operatively coupled to the communication device 136 and the memory device 140. The processing device 138 uses the communication device 136 to communicate with the network 101 and other devices on the network 101, such as, but not limited to the entity system 105, the user system 104, the reporting system 180, and the sandbox testing system 107. As such, the communication device 136 (and/or communication devices 112 and 146) generally comprises a modem, server, or other device for communicating with other devices on the network 101.

As further illustrated in FIG. 1, the processing system 106 comprises computer-readable instructions 142 stored in the memory device 140, which in one embodiment includes the computer-readable instructions 142 of a processing system application 144 having an adaptive security tool application 144a structured for adaptive targeted multi-attribute based identification of online malicious electronic content. In some embodiments, the memory device 140 includes data storage 141 (not illustrated) for storing data related to the system environment, but not limited to data created and/or used by the processing system application 144 (and specifically the adaptive security tool application 144a). In some embodiments, the processing system application 144, and specifically the adaptive security tool application 144a, is configured for adaptive targeted multi-attribute based identification of online malicious electronic content. As such, in some embodiments, the processing system 106 may comprise a framework for testing web applications which is used to drive web browser interactions.

In some embodiments, the adaptive security tool application 144a is a Python based tool having a script which is structured to be executed by the processing device 138 of the processing system 106, and which is structured for automatically extracting, via the reporting system 180, reported suspicious web resources (e.g., URLs) from Application Programming Interfaces (APIs), carrying out automated analysis on identification of a web resource such as a website associated with the reported URL, and assessing the likeliness of impersonation of an entity or its brand or products, via browser automation. The adaptive security tool application 144a then pulls relevant data from the malicious website and provides a generated intelligence report, providing the intelligence team with actionable intelligence to submit to defense teams.

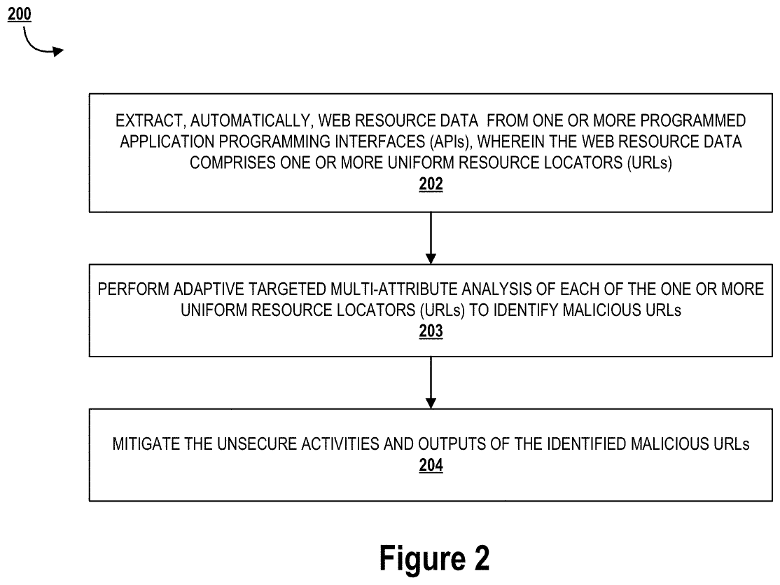

Specifically, executing computer readable instructions of 142 of the processing system application 144, via the adaptive security tool application 144a, is configured to cause processing device 138 to transmit certain control instructions to the one or more user devices 104 (e.g., 104a-104d) to cause the respective processing devices (114) to carry out one or more steps described herein, to transmit certain control instructions to the entity system(s) 105 to cause the entity system(s) 105 to carry out one or more steps described herein, and/or to transmit certain control instructions to the sandbox system 107 to cause the sandbox system 107 to carry out one or more steps described herein. Here, the processing system 106 (also referred to as “the system” herein with respect to FIGS. 2-5) is configured to provide adaptive targeted multi-attribute based identification of online malicious electronic content. The processing system 106 is structured for enhancing network security by detecting malicious web resources, extracting and dynamically analyzing web components of the malicious web resources, and preventing unsecured activity via the identified malicious web resources. The processing system 106 is structured for extracting, automatically, web resource data from one or more programmed application programming interfaces (APIs), wherein the web resource data comprises one or more uniform resource locators (URLs). The processing system 106 is also structured for performing adaptive targeted multi-attribute analysis of each of the one or more uniform resource locators (URLs) to identify malicious URLs (e.g., URLs with malicious websites which may be hosted on or whose source code may be stored on web resource server(s) 190)). The processing system 106 is further structured for mitigating the unsecure activities and outputs of the identified malicious URLs. In the embodiment illustrated in FIG. 1 and described throughout much of this specification, the processing system 106 (and specifically the adaptive security tool application 144a) may transmit indications to the user device 104 notifying the user 102 regarding the URLs determined to be malicious (e.g., informing the user that certain URLs previously access by the user are malicious which may have conducted unauthorized access of user data, informing the user that certain URLs have been determined to be malicious and blocking future access to those malicious URLs, and/or the like). The processing system 106 may communicate with the entity system(s) 105, the user device 104, the sandbox testing system 107, merchant systems, authentication/authorization systems, and web resource server(s) 190 and other third party systems (not illustrated) to perform one or more steps described above and through this disclosure, and/or cause these systems to perform one or more of these steps, at least in part.

In some embodiments, the processing system application 144 may control the functioning of the sandbox testing system 107. In some embodiments, the processing system application 144 may control the functioning of the user device 104. In some embodiments, the processing system application 144 comprises computer readable instructions 142 or computer-readable program code, that when executed by the processing device 138, causes the processing device 138 to perform one or more steps involved in adaptive targeted multi-attribute based identification of online malicious electronic content and/or to transmit control instructions to other systems and devices to cause the systems and devices to perform specific tasks associated with adaptive targeted multi-attribute based identification of online malicious electronic content. In some embodiments, the processing system 106, the sandbox testing system 107 and/or the entity system 105 may be embodied in the same system, or alternatively, the processing system 106, the sandbox testing system 107 and/or the entity system 105 may be separate systems as illustrated by FIG. 1. Moreover, in some embodiments, the processing system 106 and the sandbox testing system 107 may be embodied in the same system. Moreover, in some embodiments, the processing system 106 and the entity system(s) 105 may be embodied in the same system.

As further illustrated in FIG. 1, the entity system(s) 105 or entity system 105 generally comprises a communication device 146, a processing device 148, and a memory device 150. As discussed, as used herein, the term “processing device” or “processor” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 148 is operatively coupled to the communication device 146 and the memory device 150. The processing device 148 uses the communication device 146 to communicate with the network 101 and other devices on the network 101, such as, but not limited to the processing system 106, the user system 104 and the sandbox testing system 107. As such, the communication device 146 generally comprises a modem, server, or other device for communicating with other devices on the network 101.

As further illustrated in FIG. 1, the entity system 105 comprises computer-readable instructions 154 stored in the memory device 150, which in one embodiment includes the computer-readable instructions 154 of an entity security application 158. In some embodiments, the memory device 150 includes data storage 152 for storing data related to the system environment, but not limited to data created and/or used by the entity security application 158. In some embodiments, the entity security application 158 receives security data associated with URLs determined to be malicious by the processing system 106, and process the data and perform mitigating steps to prevent unsecured actions/outputs associated with the URLs determined to be malicious.

In the embodiment illustrated in FIG. 1 and described throughout much of this specification, the entity security application 158 may transmit indications to the user device notifying the user regarding the URLs determined to be malicious (e.g., informing the user that certain URLs previously access by the user are malicious which may have conducted unauthorized access of user data, informing the user that certain URLs have been determined to be malicious and blocking future access to those malicious URLs, and/or the like). In this way, the entity security application 158 may communicate with the processing system 106, the user device 104, merchant systems and other third party systems (not illustrated).

The sandbox testing system 107 is structured to provide a controlled and isolated testing environment for accessing, deploying, and analyzing the malicious web resources (e.g., malicious websites and URLs, etc.) without adversely impacting and compromising the security of the processing system 106 and the rest of the network devices. As such the sandbox testing system 107 may comprise restricted/isolated memory and memory scratch space for executing one or more steps of the adaptive targeted multi-attribute based identification of online malicious electronic content of the present invention.

It is understood that the servers, systems, and devices described herein illustrate one embodiment of the invention. It is further understood that one or more of the servers, systems, and devices can be combined in other embodiments and still function in the same or similar way as the embodiments described herein.

FIG. 2 illustrates a high level process flow 200 for adaptive targeted multi-attribute based identification of online malicious electronic content, in accordance with some embodiments of the invention. In particular, the high level process flow 200 illustrates the functions of enhancing network security by detecting malicious web resources, extracting and dynamically analyzing web components of the malicious web resources, and preventing unsecured actions/activity of the identified malicious web resources, of the present invention. These steps may be performed by the processing system 106, via the processing system application 144, via the adaptive security tool application 144a.

A “web resource” as used herein may refer to online resources that are connected to and accessed via a network, such as websites (also referred to as webpages). Specifically, web resources are technology resources associated with, connected to, served by, or available through a system/device/computer/server and a communications/telecommunications network (such as the Internet). Typically, each of the web resources are associated with a Uniform Resource Identifier (URI). The Uniform Resource Identifier (URI) may be a string of characters that unambiguously identifies a particular web resource and indicates the means for accessing/viewing/visiting the resource. Typically, the URIs follow a predefined set of syntax rules, and also provide for extensibility through a separately defined hierarchical naming scheme (e.g. http://). In some embodiments, web resources refer to websites or webpages which may be used interchangeably herein.

A “Uniform Resource Locator” (URL), may be a reference to a web resource that specifies its location on a computer network. Here, in some instances, the URL is a specific type of Uniform Resource Identifier (URI). URLs are typically associated with web resource such as reference web pages (e.g., via “http”), but are also used for file transfer (e.g., via “ftp”), email (e.g., via “mailto”), database access (e.g., via “JDBC”), and/or the like. Typically, web browsers display the URL of a website/webpage above the page in an address bar. A typical URL could have the form http://www.sample.com/index.html, which indicates a protocol (http), a hostname (www.sample.com), and a file name (index.html).

“Web resource data” may refer to identifying information associated with the web resources, and may comprise URIs associated with the web resources. In some embodiments, web resources refer to websites/webpages, and web resource data refers to a list of URLs associated with the websites/webpages.

As discussed previously, the adaptive security tool application 144a may comprise a script, which is structured to be executed by the processing device 138 of the processing system 106. Moreover, the adaptive security tool application 144a may be a Python based tool having the script which when executed by the processing device 138 of the processing system 106, is structured for performing the steps herein, such as automatically extracting reported suspicious web resources (e.g., URLs) from Application Programming Interfaces (APIs), carrying out automated analysis on identification of a web resource such as a website associated with the reported URL, and assessing the likeliness of impersonation of an entity or its brand or products, via browser automation. The adaptive security tool application 144a then pulls relevant data from the malicious website and provides a generated intelligence report, providing the intelligence team with actionable intelligence to submit to defense teams. The adaptive targeted multi-attribute based identification of online malicious electronic content performed by executing the script of the adaptive security tool application 144a will not be described.

First, as illustrated by block 202, the system may extract, automatically, web resource data from one or more programmed application programming interfaces (APIs). The web resource data comprises one or more uniform resource locators (URLs), e.g., in a list format. In some embodiments, as described with respect to FIG. 1 previously, users 102 of a network, via user devices 104, may flag certain web resources (websites/webpages) whose veracity cannot be confirmed and/or which require analysis to determine whether they are malicious or not. These flagged web resources (websites/webpages) whose veracity cannot be confirmed and/or which require analysis to determine whether they are malicious may then be transmitted to a reporting system 180. Here, the system 106 may then extract web resource data (URLs) associated with these flagged web resources (web sites/webpages) whose veracity cannot be confirmed and/or which require analysis to determine whether they are malicious, e.g., via API's of the network, from the reporting system 180. In addition or alternatively, in some embodiments, the system, via security tools, may itself identify web resources (websites/webpages) whose veracity cannot be confirmed (e.g., whose certificates cannot be validated) and/or which require analysis to determine whether they are malicious, e.g., via API's of the network, and extract the associated web resource data (URLs). Here, the system may extract web resource data from multiple sources and generate a list of web resources that may be potentially malicious and which may require analysis.

As such the web resource data may be in the form of a list of URLs. The system may then index the URLs. Here the system may ascertain for each of the URLs, the number of websites/webpages that are available after the forward slashes “I” therein, and determine whether these websites/webpages are accessible. If accessible, the system may add these expanded URLs to the web resource data, in some embodiments. For example, for a URL “http://www.sample.com/index1/index2” the system may index the URL via the component separator character of the URL (e.g., forward slash “/”), by (i) expanding the URL after the component separator character (e.g., forward slash “/”) to construct one or more expanded/longer URLs (e.g., http://www.sample.com/index1/index2/index3 or “http://www.sample.com/index1/index2/index3/index4”) and/or (ii) truncating the URL at the component separator character (e.g., forward slash “/”) to construct one or more truncated URLs (e.g., “http://www.sample.com/indexl”). The system may determine whether the constructed expanded URLs and/or the truncated URLs are available and valid. The system may determine that new resources are available based on ascertaining that the expanded URLs and/or the truncated URLs when executed result in the new resources. The system may then append the web resource data to include the expanded URLs and/or the truncated URLs.

Moreover, the system modify the web resource data to remove false positives. For example, certain web sites associated with the URLs may no longer be available or may have been taken down already. Moreover, certain websites associated with the URLs be owned by the entity that the malicious website is suspected to be impersonating/emulating. Here, the system may determine for each of the one or more URLs of the web resource data, (i) whether an associated web resource (website) is active, and (ii) whether the associated web resource (website) is associated with a predetermined entity. Here, the system may determine that a second URL of the one or more URLs is a false positive based on determining (i) that the associated web resource is inactive or removed, and (ii) that the associated web resource is associated with a predetermined entity, and subsequently remove the second URL from the web resource data.

In addition, the system modify the web resource data to remove duplicates. For example, because the system may extract web resource data from multiple sources, certain URLs may be repeated or may occur in the extracted data from two or more sources. The system is structured to identify and remove the duplicate occurrences.

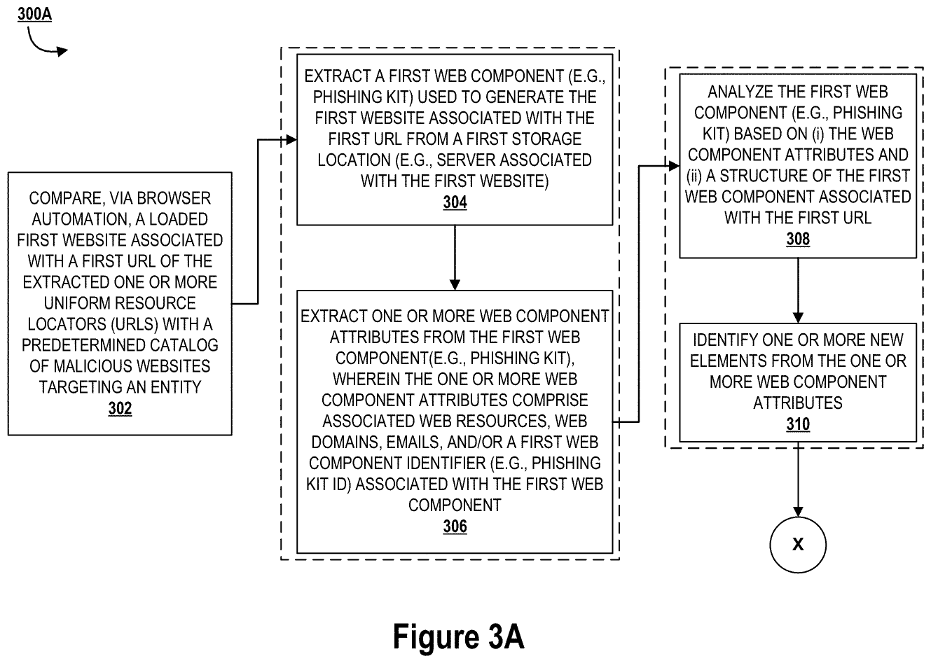

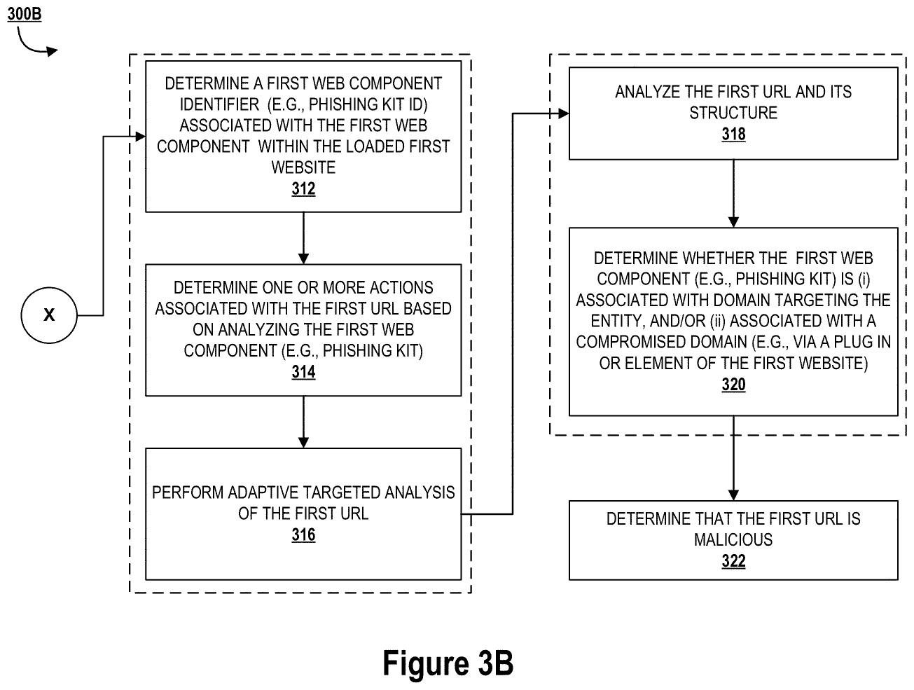

Next, as illustrated by block 203, the system, may then perform adaptive targeted multi-attribute analysis of each of the one or more uniform resource locators (URLs) to identify malicious URLs. These analysis steps are detailed later on with respect to blocks 302-322 of FIGS. 3A-3B, and may be repeated for all of the URLs in the web resource data. As such, these adaptive analysis steps may comprise comparing, via browser automation, a loaded first website (web resource) associated with a first URL of the extracted one or more uniform resource locators (URLs) with a predetermined catalog of malicious websites targeting an entity. The adaptive analysis steps may further include extracting a first web component (e.g., phishing kit) used to generate the first website associated with the first URL from a first storage location (e.g., server associated with the first website), and extracting one or more web component elements from a zipped version the first web component(e.g., phishing kit), wherein the one or more web component elements comprise associated web resources, web domains, emails, and/or a first web component identifier (e.g., phish kit id) associated with the first web component. The adaptive analysis steps may further include analyzing the first web component (e.g., phishing kit) based on (i) the web component elements (attributes) and (ii) a structure of the first web component associated with the first URL, identifying one or more new elements from the one or more web component elements, determining one or more actions associated with the first URL based on analyzing the first web component (e.g., phishing kit), performing adaptive targeted analysis of the first URL based on at least the determined one or more actions associated with the first URL, analyzing the first URL and its structure, determining whether the first web component (e.g., phishing kit) is (i) associated with domain targeting the entity, and/or (ii) associated with a compromised domain (e.g., via a plug in or element of the first website), and/or determining that the first URL is malicious.

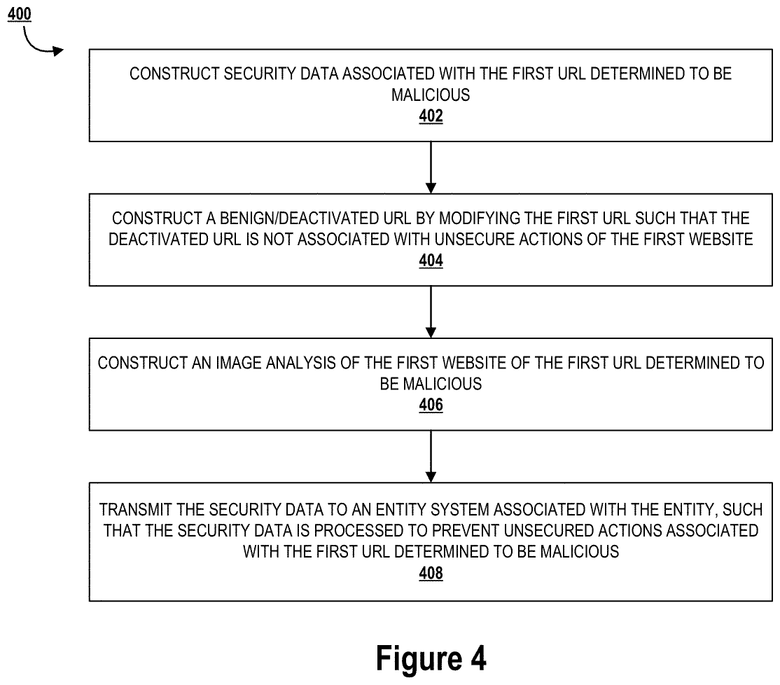

As illustrated by block 203, the system, may then mitigate the unsecure activities and outputs of the identified malicious URLs. These mitigation steps are detailed later on with respect to blocks 402-408 of FIG. 4, and may be repeated for all of the URLs in the web resource data. These steps may include constructing security data associated with the first URL determined to be malicious, constructing a deactivated URL by modifying the first URL such that the deactivated URL is not associated with unsecure actions of the first website, constructing an image analysis of the first website of the first URL determined to be malicious, and/or transmitting the security data to an entity system associated with the entity, such that the security data is processed to prevent unsecured actions associated with the first URL determined to be malicious.

FIGS. 3A and 3B illustrate high level process flows 300A-300B for dynamic identification and adaptive targeted multi-attribute analysis of web resources, in accordance with some embodiments of the invention. In particular, the high level process flows 300A-300B illustrate the steps associated with adaptive targeted multi-attribute analysis of each of the one or more uniform resource locators (URLs) to identify malicious URLs of block 203 of process flow 200 of FIG. 2. These steps may be performed by the processing system 106, via the processing system application 144 and the adaptive security tool application 144a. The system may perform the adaptive targeted multi-attribute analysis of each of the one or more uniform resource locators (URLs) to identify malicious URLs. The analysis is described with respect to a first URL of the one or more extracted URLs. However, it is understood that the steps described below with respect to blocks 302-322 may be repeated for several or all of the extracted URLs.

As illustrated by block 302, the system may perform image analysis by comparing, via browser automation, a loaded first website associated with a first URL of the extracted one or more uniform resource locators (URLs) with a predetermined catalog of malicious websites targeting an entity. The adaptive security tool application 144a allows the system to capture and save various versions of the web resources (websites) associated with the URLs. Here, the system may first load a first web resource (first website) associated with the first URL, e.g., at a browser of the sandbox system 107 in a secure manner. The system may then capture a current web resource image/screenshot from the loaded first website associated with the first URL. The system may analyze the captured current web resource image/screenshot to determine which entity or which particular product items (e.g., brands, products, services, etc.) of the entity that the first website associated with the first URL is emulating. Here, the system may determine that a portion of the web resource image (e.g., a particular logo) is associated with a particular product item (e.g., brand, product, service, etc.) of the entity. In response, the system may then determine which authentic website owned/operated by the entity is associated with particular product item (e.g., brand, product, service, etc.) of the entity that is being emulated by the first website associated with the first URL, and subsequently load the authentic website associated with the product item of the entity via a browser. The system may then capture an entity web resource image from a loaded authentic website associated with the entity. Finally, the system may compare image components (e.g., segments of the image/screenshot, logos, user interface items such as icons, text, images, etc., renderings, etc.) of the current web resource image with image components of the entity web resource image to determine a similarity indicator metric. The similarity indicator metric (e.g., a similarity grade/score) indicates to what extent or how well the first website associated with the first URL emulates/renders the authentic website associated with the entity. In other words, the similarity indicator metric (e.g., a similarity grade/score) indicates to what extent or how similar the first website associated with the first URL is to the authentic website associated with the entity.

As illustrated block 304, in some embodiments, the system may extract a first/source code web component (e.g., phishing kit) used to generate the first website associated with the first URL, from a first storage location (e.g., server associated with the first website). Typically, the first/source code web component or phishing kit is the web component, or the back-end to a malicious web resource/website. The first/source code web component or phishing kit may comprise a package of archive files with a set of scripts or source code that is the basis for the web resource/website. Typically, the first/source code web component (e.g., phishing kit) is associated with source code used to generate a first website associated with the first URL. For constructing the web resource/website, the malicious actor may create the first/source code web component or phishing kit onto a server, where it remains.

In some embodiments, for extracting the first/source code web component (e.g., phishing kit) associated with the first URL, the system may first determining the first storage location, i.e., the server, where the first web resource (website) of the first URL is hosted. The system may systematically search the first storage location for files associated with the first web resource (website) of the first URL. In particular, the system may search for zip versions of the first/source code web component (e.g., phishing kit) and/or folders having the first/source code web component (e.g., phishing kit). The system may then retrieve the first/source code web component (e.g., phishing kit) from the files associated with the first web resource (website) of the first URL. The system may analyze the source code of the first/source code web component (e.g., phishing kit) associated with the first URL to ascertain how the first web resource (website) is setup, as described below.

As illustrated block 306 (and/or in combination with block 312), in some embodiments, the system may extract one or more web component attributes/elements from the first/source code web component (e.g., phishing kit) (e.g., from a zipped version or zip file of the phishing kit). Typically, the one or more web component attributes/elements comprise associated web resources (websites), web domains, electronic communications/emails (e.g., those transmitted from/via the web resource to users), and/or a first web component identifier (e.g., phishing kit ID) associated with the first web resource/website. In some instances, the first web component identifier (e.g., phishing kit ID) is structured for uniquely identifying the corresponding web resource. In some embodiments, for determining the one or more web component attributes, the system may analyze the first/source code web component (e.g., phishing kit) associated with the first URL, the web resource/website and/or the first URL itself. Moreover, the system may search/parse the first storage location for additional files associated with the one or more web component attributes. The system may then retrieve the additional files associated with the one or more web component attributes from the first storage location.

As illustrated block 308, the system may perform code review by analyzing the first web component (e.g., phishing kit) based on (i) the web component elements and (ii) a structure of the first/source code web component (e.g., phishing kit) associated with the first URL. In response, the system may perform bespoke analysis/investigation of the first web component (e.g., phishing kit) based on the findings of the code review (as indicated by block 316). Here, the system configure an adaptive analysis action for analyzing the first URL of the one or more URLs based on at least (i) the web component attributes and (ii) a structure of the first/source code web component (e.g., phishing kit) associated with the first URL and then implement the adaptive analysis action for determining whether the first URL is malicious.

In some embodiments, here, the system analyzes the source code and the structure of the first/source code web component (e.g., phishing kit) to identify any new elements that may not have been previously seen, as indicated by block 310. As discussed previously, the first/source code web component (e.g., phishing kit) may comprise a package (e.g., zipped folder) of files associated with generating the corresponding web resource/website. Moreover, each first/source code web component (e.g., phishing kit) is typically associated with a web component identifier (e.g., phishing kit ID). It is noted that, in some embodiments, the web component identifier (e.g., phishing kit ID) may not be available or may not be able to be obtained from first/source code web component (e.g., phishing kit) package/files (as described with respect to block 306). Here, as illustrated by block 312, the system is structured to determine the web component identifier (e.g., phishing kit ID) associated with the first/source code web component (e.g., phishing kit) from within the loaded first web resource/website. Here, the system may load the first web resource (website) associated with the first URL, e.g., at a browser of the sandbox system 107 in a secure manner. The system may then search for the web component identifier (e.g., phishing kit ID) from within the loaded first web resource/website.

The system is structured to track the web component identifiers (e.g., phishing kit IDs) over time. Here, the system typically stores a list of files that are normally included in the first/source code web component (e.g., phishing kit) package/folder. The system is able to track/identify/determine if a new file is seen in the first/source code web component (e.g., phishing kit) or if an existing file has been revised or updated. As such, the system is able to track the changes to the first/source code web component (e.g., phishing kit) over time, and in response adapt/tailor/customize the analysis to determine the causes, effects, patterns, etc. of the changes.

Here, the system may determine prior files associated with the web component identifier (e.g., phishing kit ID) associated with a previous version of the web resource (website) the first URL (e.g., identified during the source code, structure and element analysis of the first/source code web component (e.g., phishing kit) at block 308). The system may then search the first storage location (server) for current files associated with a current version of the web resource (website) the first URL. The system may then identify new files/elements in the current files (and/or any other changes/revisions to the files) associated with the current version of web resource (website) of the first URL that are absent from the prior files associated with the previous version of the web resource (website) of the first URL (as indicated by block 310). In response, the system may ascertain that the web resource (website) of the first URL has undergone an update. Moreover, the system may configure an adaptive analysis action is configured specifically based on the particulars of the determined update of the web resource (website) of the first URL (as indicated by block 316). For instance, in response to identifying a new file, the system may configure an adaptive analysis action for analyzing/investigating the new file. The adaptive analysis action is structured for extracting and processing the identified new files. For example, the system may implement the adaptive analysis action, and upon processing the new file the system may determine that the new file is an image file. The adaptive analysis action further determines that the image file is associated with a revised logo of an entity. Here, the system may further determine that the logo of in the first web resource/website of the first URL has revised in the update, to mimic a revised logo in the authentic website of the entity. Here, the system may determine that the first URL is likely malicious because it is impersonating an authentic website.

Other adaptive analysis actions that may be configured based on the specific attributes/elements/characteristics/components of the first/source code web component (e.g., phishing kit) (e.g., identified during the source code, structure and element analysis of the first/source code web component (e.g., phishing kit) at block 308). As illustrated by block 314, in some embodiments, the system may determine one or more actions associated with the first URL based on analyzing the first web component (e.g., phishing kit). Here, the system may determine one or more actions initiated by the web resource (website) associated with the first URL, upon execution. These actions may include the actions/activities performed by the web resource (website) upon loading the website and/or upon providing certain user inputs (e.g., clicking on/selecting certain displayed elements of web resource (website)). For instance, the system may determine that the web resource (web site) associated with the first URL performs an action of capturing location information of a user device upon loading of the web resource (website). For instance, the system may determine that the web resource (website) associated with the first URL performs an action of redirecting the user to another web resource (website). For instance, the system may determine that the web resource (website) associated with the first URL performs an action of transmitting an electronic communication (email) to the user upon the user providing an email address at the web resource (website). Examples of unsecured actions may include unauthorized downloads, unauthorized data access/retrieval or interception, deleting data from a user device, sending spam, unauthorized redirecting to untrustworthy sites, presenting unsecure spoof interfaces for the purposes of unauthorized data gathering, and the like. Here, the system may deploy the web resource/website of the first URL in an isolated testing environment system of the sandbox testing system 107 that is isolated/quarantined/inaccessible from the rest of the processing system 106 and the network environment 100.

Next, the system may determine whether these actions performed by the web resource/website are unsecure or whether they imperil the security of the user data and user devices, by tailoring/adapting the analysis to the specific actions being performed (as indicated by block 316). Here, the system may determine that a first action of the one or more actions is an unsecure action which is likely to adversely affect the security of the user data and user devices. Here, the system may configure/adapt/tailor the adaptive analysis action is configured based on the determined unsecure action, wherein the new adaptive analysis is structured for analyzing the unsecure action to determine whether the first URL is malicious (e.g., as indicated by block 322).

In some embodiments, the system may determine that the web resource (website) associated with the first URL performs an unsecure action of downloading a file onto the user device upon loading of the web resource (website), e.g., without requesting permission from the user. The system may then structure a new adaptive analysis action to search the first storage location (server) for files associated with the determined unsecure action, such as the files that the web resource/website is downloading onto the user device. Upon implementing the new adaptive analysis action the system may identify, extract and analyze the file to determine the type of threats associated with the unsecure download (e.g., whether the unsecured download is a malicious executable file that causes a program to be installed). Upon determining that the file is unsecure, the system may determine that the first web resource/website associated with the first URL is malicious (e.g., as indicated by block 322). As a non-limiting example, alternatively, for a second web resource/website of a second URL that is not associated with downloading the file, the system may not configure and perform the adaptive analysis action to search the relevant files and perform the analysis of the files.

In some embodiments, the system may determine that the web resource (website) associated with the first URL performs an unsecure action of requesting the user to input user authentication credentials (e.g., login information, user names, passwords, etc.) or user personal information (e.g., addresses, phone numbers, financial/account information, etc.), while superstitiously mimicking an authentic website of an entity. The system may then structure a new adaptive analysis action to search the first storage location (server) for files associated with the determined unsecure action, such as the files associated with the user input. Upon implementing the new adaptive analysis action the system may identify, extract and analyze the file to determine the type of input data being requested. Here, the system may determine that the first web resource/website associated with the first URL is malicious (e.g., as indicated by block 322).

In some embodiments, the system may determine that the web resource (website) associated with the first URL performs an unsecure action of transmitting an unsolicited electronic communication (email) to the user. The system may then structure a new adaptive analysis action to analyze the emails being sent to the user, and the source/sender information. Upon implementing the new adaptive analysis action the system may identify, extract and analyze the email to determine the type of threats associated therewith. For instance, the system may determine that the emails sent mimic the look-and-feel of authentic emails (e.g., shipping notification emails, shipped order tracking messages, etc.) that are normally transmitted by the entity that the first web resource/website is simulating/mimicking. As another instance, the system may determine that the transmitted email to the user is structured for causing an unauthorized activity when the user merely opens or reads the email. As another instance, the system may determine that the transmitted email comprises an attachment, and further analyzes the attachments to determine that the attachment is a malicious attachment. Here, the system may determine that the first web resource/website associated with the first URL is malicious (e.g., as indicated by block 322). As a non-limiting example, alternatively, the system may determine that the system may determine that the first web resource/website associated with the first URL is not malicious in the instances where the emails being sent are spam emails.

Moreover, the system may determine the users affected by the unsecured actions of the web resource/website of the first URL. For example, the system may configure and implement an adaptive analysis action for searching for and extracting files associated with user information (e.g., files with the unsecure collected user data). The system may automatically then notify the users indicating that the first URL is malicious, and that their user data may have been accessed by malicious actors. In some embodiments, the system may block the malicious URLs at the user devices.

In some embodiments, as indicated by block 318, the system may analyze the first URL and its structure. Here, as illustrated by block 320, the system is structured to determine whether the first web component (e.g., phishing kit) is (i) associated with domain targeting the entity, and/or (ii) associated with a compromised domain (e.g., via a plug in or element of the first website). Here, the system may configure and implement an adaptive analysis action for analyzing the domain, the sub-domain, and/or the path structure of the first URL. The system may then determine whether the first/source code web component (e.g., phishing kit) is (i) associated with a third-party domain targeting the entity (e.g., a malicious website impersonating an authentic website of the entity), and/or is (ii) associated with a compromised domain of the entity (a security compromise of an authentic web resource/website of the entity via a vulnerability of a plugin associated with the authentic web resource/website). In some embodiments, the system may analyze the (i) the web component attributes and (ii) a structure of the first/source code web component (e.g., phishing kit) associated with the first URL. Here, the system may not identify an exact match for a product item (e.g., brand, product, service, etc.) of the entity (e.g., a brand name “Brand1”). Here, the system may further configure the adaptive analysis action for determining preprogrammed alterations of the product item, e.g., via fuzzy logic, by adding, removing and/or substituting characters. The adaptive analysis of the system may identify that the first web resource/website associated with the first URL includes one or more preprogrammed alteration of a product item of the entity (e.g., preprogramed alterations of the brand name—“Braand1”, “Brnd”, “Brandd1”, etc.). Here, the system may determine that the first URL is associated with a third-party domain targeting the entity (e.g., a malicious website impersonating an authentic website of the entity).

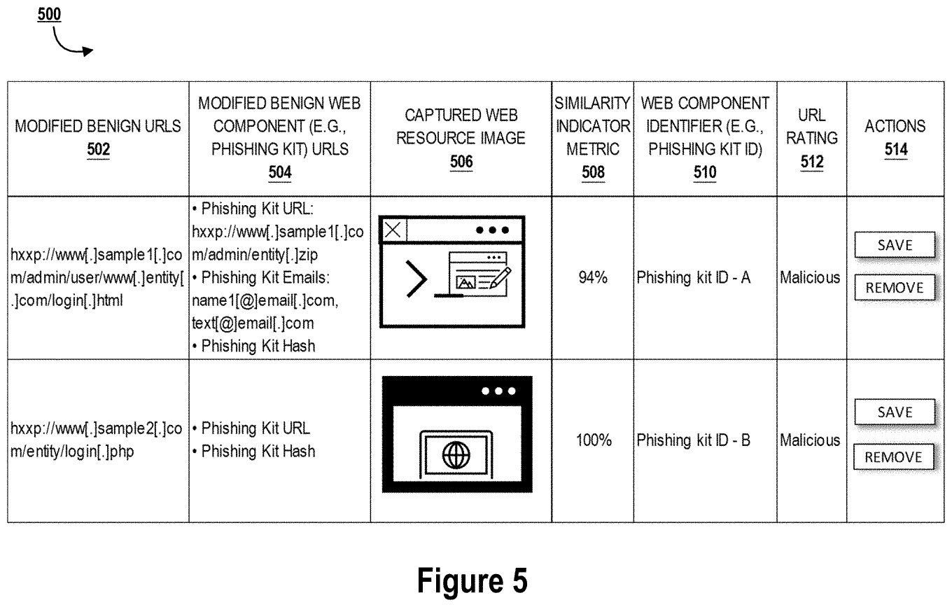

FIG. 4 illustrates a high level process flow 400 for mitigation of the unsecure activities and outputs of the identified malicious URLs, in accordance with some embodiments of the invention. In particular, the high level process flow 400 illustrates the steps associated with mitigation of the unsecure activities and outputs of the identified malicious URLs of block 204 of process flow 200 of FIG. 2. These steps may be performed by the processing system 106, via the processing system application 144 and the adaptive security tool application 144a. Although these steps are with respect to a first URL of the one or more extracted URLs, it is understood that the steps described below with respect to blocks 402-408 may be repeated for several or all of the extracted URLs. FIG. 5 depicts a schematic illustration of constructed security data 500 , in accordance with some embodiments of the invention.

As illustrated by block 402, the system is structured to construct security data associated with URLs determined to be malicious. In some embodiments, the security data comprises indicators of compromise (IOCs). In some embodiments, the system may construct the security data in the form of a one-page intelligence report e.g., for review/processing by a security system/individual associated with the entity.

The construction of the security data will now be described with respect to FIG. 5, in conjunction with FIG. 4. Here, the system may construct defanged/benign/deactivated URLs 502 by transforming/modifying the URLs determined to be malicious. As illustrated block 404, the system may construct a deactivated URL 502 by modifying the first URL such that the deactivated URL is not associated with unsecure actions of the first website and cannot be clicked or otherwise acted upon to inadvertently access the malicious web resource. Here, the system may modify/replace/remove one or more characters of the URL or add one or more characters to the URL to deactivate/defang the URL. For instance, the system may alter certain characters in the protocol portion of the URL to deactivate it, such as replace the “t” character with an “x” character in “http”. Moreover, the system may alter separator/extension characters of the URL to deactivate it, such as add brackets “[” and “]” around “.” characters. Here, a first extracted URL of “http://www.sample1.com/admin/user/www.entity.com/login.html” may be transformed to a benign version “hxxp://www[.]sample1[.]com/admin/user/www[.]entity[.]com/login[.]html”. Similarly, a second extracted URL of “http://www.sample2.com/entity/login.php” may be transformed to a benign version “hxxp://www[.]sample2[.]com/entity/login[.]php”.

Similarly, the system may construct deactivated/benign URLs for the identified source code web components (e.g., phishing kits) 504 (identified at block 304 of FIG. 3A). Moreover, as illustrated at FIG. 5, the deactivated source code web component (e.g., phishing kit) URLs may further comprise deactivated web component attributes/elements, such as phishing kit emails and phishing kit hashes (identified at block 306 of FIG. 3A).

As illustrated block 406, in some embodiments, the system may construct an image analysis of the first website of the first URL determined to be malicious. As previously described with respect to block 302, the system may perform image analysis by comparing, via browser automation, a loaded first website associated with a first URL of the extracted one or more uniform resource locators (URLs) with a predetermined catalog of malicious websites targeting an entity. The adaptive security tool application 144a allows the system to capture and save various versions of the web resources (websites) associated with the URLs. Here, the system may first load a first web resource (first website) associated with the first URL, e.g., at a browser of the sandbox system 107 in a secure manner. The system may then capture a current web resource image/screenshot 506 from the loaded first website associated with the first URL. The system may then determine which authentic website owned/operated by the entity is associated with particular product item (e.g., brand, product, service, etc.) of the entity that is being emulated by the first website associated with the first URL, and subsequently load the authentic website associated with the product item of the entity via a browser. The system may then capture an entity web resource image from a loaded authentic website associated with the entity. Finally, the system may compare image components (e.g., segments of the image/screenshot, logos, user interface items such as icons, text, images, etc., renderings, etc.) of the current web resource image with image components of the entity web resource image to determine a similarity indicator metric 508. The similarity indicator metric 508 (e.g., a similarity grade/score) indicates to what extent or how well the first website associated with the first URL emulates/renders the authentic website associated with the entity. In other words, the similarity indicator metric 508 (e.g., a similarity grade/score) indicates to what extent or how similar the first website associated with the first URL is to the authentic website associated with the entity. Moreover, the system may include the web component identifier 510 (phishing kit ID) in the security data 500, along with URL ratings 512 indicating whether the URLs were determined to be malicious. In addition, the security data 500 may allow actions 514 associated with the security data of each of the URLs. As such, an individual associated with the entity reviewing the security data may save or remove particular URL security data.

Next, at block 408, the system may transmit the security data to an entity system associated with the entity, such that the security data is processed to prevent unsecured actions associated with the first URL determined to be malicious. Here, the system may transmit control signals to storage location (server) of the web resource/website associated with the URL determined to be malicious, and cause the storage location (server) to delete/remove the source code web components (e.g., phishing kits) and other files associated with the web resource/website associated with the URL.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for adaptive targeted multi-attribute based identification of online malicious electronic content, wherein the system is structured for enhancing network security by extracting and dynamically analyzing web components of malicious web resources, and mitigating unsecured activity via identified malicious web resources, the system comprising:
a memory device with computer-readable program code stored thereon;
a communication device, wherein the communication device is configured to establish operative communication with a plurality of networked devices via a communication network;
a processing device operatively coupled to the memory device and the communication device, wherein the processing device is configured to execute the computer-readable program code to:
extract web resource data from one or more programmed application programming interfaces (APIs), wherein the web resource data comprises one or more uniform resource locators (URLs);
extract a source code web component associated with a first URL of the one or more URLs from a first storage location, wherein the source code web component is associated with source code used to generate a first website associated with the first URL;
determine one or more web component attributes of the source code web component associated with the first URL based on analyzing the source code web component, wherein the one or more web component attributes comprise a source code web component identifier associated with the source code web component;
analyze the source code web component based on (i) the web component attributes and (ii) a structure of the source code web component associated with the first URL;
configure an adaptive analysis action for analyzing the first URL of the one or more URLs based on at least (i) the web component attributes and (ii) a structure of the source code web component associated with the first URL;
implement the adaptive analysis action for determining whether the first URL is malicious;
in response to determining that the first URL is malicious URL, construct security data associated with the first URL; and
transmit the security data to an entity system associated with an entity, such that the security data is processed to prevent unsecured actions associated with the first URL determined to be malicious.

2. The system of claim 1, wherein the source code web component is a phishing kit associated with the first URL, and wherein the source code web component identifier is a phishing kit ID.

3. The system of claim 1, wherein the processing device is configured to further execute the computer-readable program code to:
load, a first web resource associated with the first URL, wherein the first web resource is a first website associated with the first URL;
capture a current web resource image from the loaded first website associated with the first URL;
capture an entity web resource image from a loaded authentic website associated with the entity; and
compare image components of the current web resource image with image components of the entity web resource image to determine a similarity indicator metric.

4. The system of claim 3, wherein capturing the entity web resource image further comprises:
determining that a portion of the web resource image is associated with an product item;
determining that the product item is associated with the entity;
determining an authentic website associated with the product item of the entity; and
loading the authentic website associated with the product item of the entity.

5. The system of claim 1, wherein the first storage location is a server location, wherein the first URL is associated with a first web resource comprising a first website, wherein extracting the source code web component associated with the first URL further comprises:
determining the first storage location associated with the first web resource of the first URL;
searching the first storage location for files associated with the first web resource of the first URL; and
retrieving the source code web component from the files associated with the first web resource of the first URL.

6. The system of claim 1, wherein the one or more web component attributes further comprise a web domain, a web resource, and/or an electronic communication associated with the source code web component.

7. The system of claim 1, wherein analyzing the source code web component based on the web component attributes and the structure of the source code web component associated with the first URL, further comprises:
determining prior files associated with the source code web component identifier associated with a previous version of the web resource of the first URL;
searching the first storage location for current files associated with a current version of the web resource of the first URL; and
in response to identifying new files in the current files associated with the current version of the web resource of the first URL that are absent from the prior files associated with the previous version of the web resource of the first URL, determine an update of the web resource of the first URL; and
wherein the adaptive analysis action is configured based on the determined update of the web resource of the first URL, wherein the adaptive analysis is structured for extracting and processing the identified new files to determine whether the first URL is malicious.

8. The system of claim 1, wherein analyzing the source code web component based on the web component attributes and the structure of the source code web component associated with the first URL, further comprises:
determining one or more actions initiated by the web resource associated with the first URL upon execution; and
determining that a first action of the one or more actions is an unsecure action; and
wherein the adaptive analysis action is configured based on the determined unsecure first action, wherein the adaptive analysis action is structured for analyzing the unsecure first action to determine whether the first URL is malicious.

9. The system of claim 8, wherein the adaptive analysis action is structured for:
searching the first storage location for files associated with the determined unsecure first action; and
based on the files associated with the unsecure first action, determining one or more users affected by the unsecure first action.

10. The system of claim 1, wherein analyzing the source code web component based on the web component attributes and the structure of the source code web component associated with the first URL comprises determining that the web resource of the first URL comprises a preprogrammed alteration of a product item of the entity, wherein the adaptive analysis action is structured for:
analyzing a domain, a sub-domain, and/or a path structure of the first URL; and
determining whether the source code web component is (i) associated with a third-party domain targeting the entity, and/or is (ii) associated with a compromised domain of the entity.

11. The system of claim 1, wherein the security data associated with the first URL comprises the source code web component and/or the web component attributes, wherein constructing the security data associated with the first URL further comprises:
constructing a benign deactivated URL by modifying the first URL such that the deactivated URL is not associated with unsecure actions of the first website; and
constructing an image analysis of the web resource of the first URL determined to be malicious.

12. The system of claim 1, wherein determining the one or more web component attributes of the source code web component associated with the first URL further comprises:
searching the first storage location for additional files associated with the one or more web component attributes; and
retrieving the additional files associated with the one or more web component attributes from the first storage location.

13. The system of claim 1, wherein the processing device is configured to further execute the computer-readable program code to modify the web resource data, comprising:
determining, for each of the one or more URLs of the web resource data, (i) whether an associated web resource is active, and (ii) whether the associated web resource is associated with a predetermined entity;
determining that a second URL of the one or more URLs is a false positive based on determining (i) that the associated web resource is inactive or removed, and (ii) that the associated web resource is associated with a predetermined entity; and
removing the second URL from the web resource data.

14. The system of claim 1, wherein the processing device is configured to further execute the computer-readable program code to process the extracted web resource data, comprising:
indexing, for each of the one or more URLs of the web resource data, via a component separator character of the URL, by (i) expanding the URL after the component separator character and/or (ii) truncating the URL at the component separator character;
determining, for each of the one or more URLs of the web resource data, availability of new web resources based on determining that the new web resources are associated with the expanded URL and/or the truncated URL; and
appending the web resource data to include the expanded URL and/or the truncated URL.

15. A computer program product for adaptive targeted multi-attribute based identification of online malicious electronic content, wherein the computer program product is structured for enhancing network security by extracting and dynamically analyzing web components of malicious web resources, and mitigating unsecured activity via identified malicious web resources, the computer program product comprising a non-transitory computer-readable storage medium having computer-executable instructions for causing a computer processor to:
extract web resource data from one or more programmed application programming interfaces (APIs), wherein the web resource data comprises one or more uniform resource locators (URLs);
extract a source code web component associated with a first URL of the one or more URLs from a first storage location, wherein the source code web component is associated with source code used to generate a first website associated with the first URL;
determine one or more web component attributes of the source code web component associated with the first URL based on analyzing the source code web component, wherein the one or more web component attributes comprise a source code web component identifier associated with the source code web component;
analyze the source code web component based on (i) the web component attributes and (ii) a structure of the source code web component associated with the first URL;
configure an adaptive analysis action for analyzing the first URL of the one or more URLs based on at least (i) the web component attributes and (ii) a structure of the source code web component associated with the first URL;
implement the adaptive analysis action for determining whether the first URL is malicious;
in response to determining that the first URL is malicious URL, construct security data associated with the first URL; and
transmit the security data to an entity system associated with an entity, such that the security data is processed to prevent unsecured actions associated with the first URL determined to be malicious.

16. The computer program product of claim 15, wherein the source code web component is a phishing kit associated with the first URL, and wherein the source code web component identifier is a phishing kit ID.

17. The computer program product of claim 15, wherein analyzing the source code web component based on the web component attributes and the structure of the source code web component associated with the first URL, further comprises:
determining prior files associated with the source code web component identifier associated with a previous version of the web resource of the first URL;
searching the first storage location for current files associated with a current version of the web resource of the first URL; and
in response to identifying new files in the current files associated with the current version of the web resource of the first URL that are absent from the prior files associated with the previous version of the web resource of the first URL, determine an update of the web resource of the first URL; and
wherein the adaptive analysis action is configured based on the determined update of the web resource of the first URL, wherein the adaptive analysis action is structured for extracting and processing the identified new files to determine whether the first URL is malicious.

18. A computerized method for adaptive targeted multi-attribute based identification of online malicious electronic content, wherein the computerized method is structured for enhancing network security by extracting and dynamically analyzing web components of malicious web resources, and mitigating unsecured activity via identified malicious web resources, the computerized method comprising:
extracting web resource data from one or more programmed application programming interfaces (APIs), wherein the web resource data comprises one or more uniform resource locators (URLs);
extracting a source code web component associated with a first URL of the one or more URLs from a first storage location, wherein the source code web component is associated with source code used to generate a first website associated with the first URL;
determining one or more web component attributes of the source code web component associated with the first URL based on analyzing the source code web component, wherein the one or more web component attributes comprise a source code web component identifier associated with the source code web component;
analyzing the source code web component based on (i) the web component attributes and (ii) a structure of the source code web component associated with the first URL;
configuring an adaptive analysis action for analyzing the first URL of the one or more URLs based on at least (i) the web component attributes and (ii) a structure of the source code web component associated with the first URL;
implementing the adaptive analysis action for determining whether the first URL is malicious;
in response to determining that the first URL is malicious URL, constructing security data associated with the first URL; and
transmitting the security data to an entity system associated with an entity, such that the security data is processed to prevent unsecured actions associated with the first URL determined to be malicious.

19. The computerized method of claim 18, wherein the source code web component is a phishing kit associated with the first URL, and wherein the source code web component identifier is a phishing kit ID.

20. The computerized method of claim 18, wherein analyzing the source code web component based on the web component attributes and the structure of the source code web component associated with the first URL, further comprises:
determining prior files associated with the source code web component identifier associated with a previous version of the web resource of the first URL;
searching the first storage location for current files associated with a current version of the web resource of the first URL; and
in response to identifying new files in the current files associated with the current version of the web resource of the first URL that are absent from the prior files associated with the previous version of the web resource of the first URL, determine an update of the web resource of the first URL; and
wherein the adaptive analysis action is configured based on the determined update of the web resource of the first URL, wherein the adaptive analysis action is structured for extracting and processing the identified new files to determine whether the first URL is malicious.
